(19) United States
(12) Patent Application Publication
(10) Pub. No.: US 2005/0198669 A1
(43) Pub. Date: Sep. 8, 2005

(54) Method for computer system to load audio/video data from remote server

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/066,209

(22) Filed: Feb. 28, 2005

(30) Foreign Application Priority Data
Mar. 2, 2004 (TW) 093105445

(51) Int. Cl. H04N 7/173; H04N 7/16; G06F 9/44; H04N 5/445; G06F 3/00; H04N 7/14

(52) U.S. Cl. 725/50; 725/132; 725/140; 725/152; 717/100

(57) ABSTRACT

A method for computer systems to load audio/video data from remote servers is disclosed. When users of computer systems intend to watch films or audio/video programs, an initiated signal is sent to a central processing unit of the computer system. Then under an operating system with lower system resource consumption, the central processing unit sends a connection signal to a network unit of the computer system to connect with a remote service for loading data of films or audio/video programs that users want to watch into a display unit of the computer system. Thus the convenience for users to watch programs or films is enhanced and the computer system resource consumption is reduced.

### BACKGROUND OF THE INVENTION

The present invention relates to a method for computer systems to load audio/video data from remote servers, especially to a computer system under the operating system with lower system resource

Nowadays computers have become an important assistant for our daily lives. Computers combine functions of data processing function with internet as well as multimedia entertainment. In intense and increasingly competitive society nowadays, people are under high work stress. After returning home from work, the best entertainment for them is to watch TV programs or videotapes on sofas. By this way, people can release the stress, relax the tired body and mind, and dispel the fatigue rapidly after work. Thus computers are not only an important assistant for our daily lives, but also providing entertainment for us.

Most of the computer systems available now has integrated with multimedia display system so that there is no need to buy audio video equipment for displaying VCD, or DVD so as to avoid the occupation of interior space. When people are exhausting after work and would like to want audio/video programs or movies, they still need to go to video stores for videos, DVDs and game Rentals. Once the programs or movies has been borrowed, people are disappointed. It's not only inconvenience but also waste of time. Moreover, due to the requirements for prevention of computer virus infection, system management and system stability, loadings and resources consumption of Windows operating system keep increasing. Even only a single application program is used, users still need to wait for a longer time to turn on the computer system. This causes waste of time and lower efficiency.

### SUMMARY OF THE INVENTION

Therefore it is a primary object of the present invention to provide a method for computer systems to load audio/video data from remote servers by which users can set up internet connection between the computer system and the remote server for downloading audio/video data and displaying it on the computer system under an operating system with lower system resource consumption. This is convenient for users to watch audio/video programs or films as well as reducing resource consumption of the computer system.

It is another object of the present invention to provide a method for computer systems to load audio/video data from remote servers that reduces work loading of the central processing unit to save power when the computer system displays the audio/video programs or films from the remote server.

It is a further object of the present invention to provide a method for computer systems to load audio/video data from remote servers that downloads the display windows and background information related to the topic of the audio/video data simultaneously when the computer system downloads the audio/video programs or films from the remote server for display. Thus when the audio/video programs or films is displayed, the display windows and background of the computer system change at the same time so as to increase varieties of the audio/video data and improve visual quality to new heights.

The present invention discloses a method for computer systems to load audio/video data from remote servers. The method users a computer system installed with a first operating system and a second operating system. The second operating system is an operating system with lower resource consumption. The method in accordance with the present invention includes a plurality of steps. Firstly, receiving an initial signal from the user in remote end by a central processing unit; after receiving the initial signal, the central processing unit sends a connection signal to a network unit of the computer system under the second operating system; then, the network unit receives the connection signal and the computer system connects to a remote server so as to download audio/video data to the computer system. Finally, the downloaded audio/video data is displayed on a display unit for users viewing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment in accordance with the present invention;

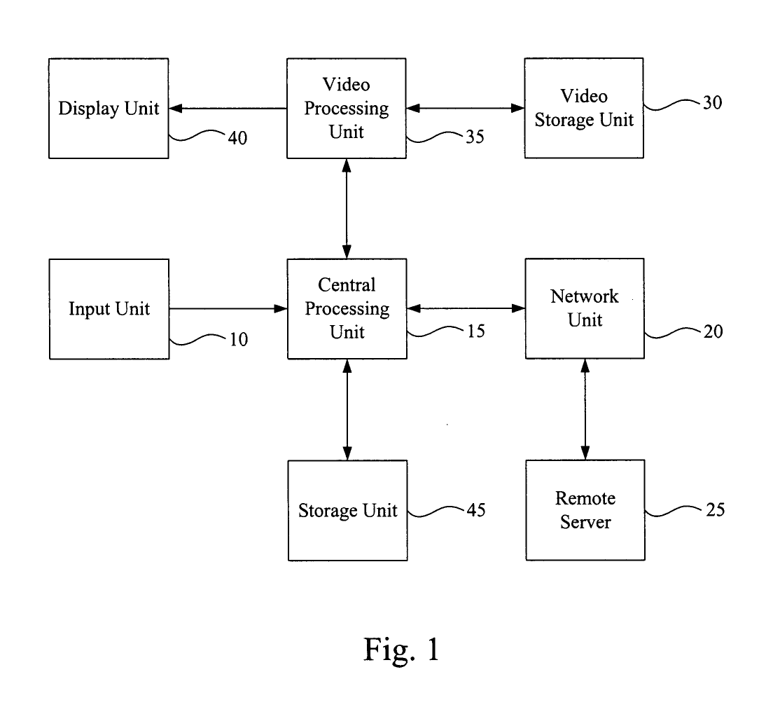

FIG. 2 is a flow chart of an embodiment in accordance with the present invention; and

FIG. 3 is a block diagram of another embodiment in accordance with the present invention.

### DETAILED DESCRIPTION OF THE PREFFERED EMBODIMENT

A computer system includes an input unit 10 that is a remote controller for the convenience of users to operate the computer system in remote end; a central processing unit 15 for receiving external instructions from users; a network unit 20 controlled by the central processing unit 15 for executing network connection; a remote server 25 for saving audio video data of programs, movies, related display windows as well as background information to be downloaded by remote computer system; a video storage unit 30 for temporarily saving the audio video data being downloaded from the remote server 25 to the network unit 20; a video processing unit 35 processing the audio video data inside the video storage unit 30 and displaying the data on a display unit 40; and a storage unit 45 for saving the audio video data downloaded by the network unit 20. The storage unit 45 can be a hard disk.

A first operating system and a second operating system are installed in the computer system in accordance with the present invention. The first operating system having higher system resource consumption is a Windows operating system such as Windows XP, Windows NT, Window 98, Windows 2000 and Windows Me, with at least one application program installed therein. The second operating system is an operating system with lower system resource consumption such as Linux operating system and is used as an operating system after the computer system being booted.

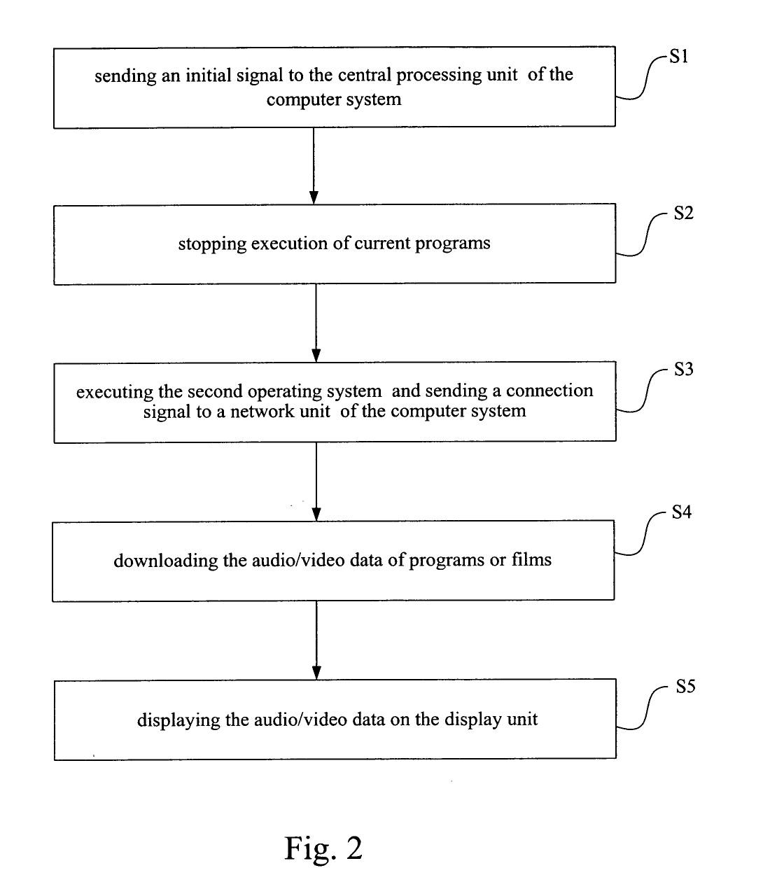

Refer to FIG. 2, when users want to watch audio/video programs or films by use of the computer system, they only need to press the input device 10 such as a remote controller to send an initial signal to the central processing unit 15 of the computer system, as shown in step S1. Refer to step S2, after receiving the initial signal, the central processing unit 15 interrupts the computer system, that is stopping execution of current programs. For example, the current programs are run by the computer system under the first operating system, the central processing unit 15 temporarily stops the execution of the first operating system. Then, as shown in step S3, the second operating system is executed and a connection signal is sent to a network unit 20 of the computer system by the central processing unit 15.

Refer to step S4, the network unit 20 receives the connection signal and downloads the audio/video data of programs or films users want to watch through the internet connection with the remote server 25. The audio/video data being downloaded is processed and transmitted to the video storage unit 30 by the central processing unit 15. At last, as shown in step S5, the downloaded audio/video data is decoded and processed by the video processing unit 35 for being transmitted to and displayed on the display unit 40. Thus users can watch the audio/video programs or films.

Moreover, in step S4, when set up the internet connection with the remote server 25 for downloading audio/video data, the display windows and background information related to the topic of the audio/video data can also be downloaded. Thus while the audio/video data of the programs or films is displayed in step S5, the display windows and background information of the display unit 40 are replaced by the related topic at the same time so as to increase the variety of the audio/video data and enhance visual effect of users. Furthermore, after being downloaded by the network unit 20, the audio/video data is saved into the storage unit 45 through the central processing unit 15. At the same time, an index table has also been established for saving the locations of the audio/video data in the storage unit 45. For example, when the downloaded audio/video data is in MPEG format, an index table contains locations of each intra frame (I frame) is established so as to reduce the time for recording audio/video data onto a disk and increase the display fluency of the audio/video data after being fast forwarded. The details are described as following.

MPEG data is an encoded data stream which contains compressed audio and video information, having three types of coded frames—an I (Intra) frame, a P (Predicted) frame, and a B (Bi-directional) frame. The pictures start by encoding a complete representation of the first frame, similar to a JPEG image. This is known as an Intra-Frame (or I-Frame). The redundant and repeated information is dealt with by mathematical techniques such as Discrete Cosine Transform (DCT), Quantization and Huffman Encoding. Generally, most frames are similar to the ones preceding as well as succeeding them. P frame depends on the preceding frame—I frame, only differences between the frames can be encoded. That is, for areas of the images which have not changed between the two frames, they are skipped while for areas that have changed slightly compared to the reference frame, they are encoded and saved. B frame depends on both the preceding as well as the succeeding frame. There are two other frames necessary to reconstruct the B frame. Using forward and backward frames allows interpolation of two frames. In practice, the sizes of the I-frames are biggest while the B-frames have the smallest sizes. There is no certain sequence of these three types of frames.

P frame and B frame are predicted from the preceding and the succeeding frames. It is impossible to reconstruct them without the data of other frame. I (Intra) Frame coding techniques restrict themselves to compressing information contained within a particular frame. It can be reconstructed without any reference to other frames. Thus I frame is a reference frame. P frame and B frame need to take into account information of I frame. Therefore, when display MPEG data, the I frame must be found first because a group of pictures starts with an I frame and ends with frame right before next I frame. When users stop in fast forward mode, if the frame is not I frame, the display software looks for previous I frame for displaying the last frame of the video. This introduces a delay after fast forwarding of the video data. Furthermore, when burning the MPEG data onto an optical storage medium, the computer system needs to search the locations of each I frame and then starts burning process. Thus users need to wait for a period of time-lead time for burning.

When saves the audio/video data, the present invention establishes an index table to record locations of each intra frame in MPEG format data. Thus during the recording process, the index table is also recorded directly so that there is no need to search the location of the I frame. Therefore, time for recoding is shortened and the display fluency of the data after being fast forwarded is increased. Moreover, when the audio/video data is saved in the storage unit 45, a storage file is opened on the storage unit 45 of the computer system. After downloading a period of time, or certain amount of data being downloaded, the computer system opens another storage file and keeps saving the audio/video data in the new storage file until all the audio/video data has been downloaded. The duration and size of the storage files can be set in the computer system by users. The audio/video data saved in storage files with certain durations or sizes by the method of the present invention is convenient for users to be burned on optical disks for the convenience of carriage.

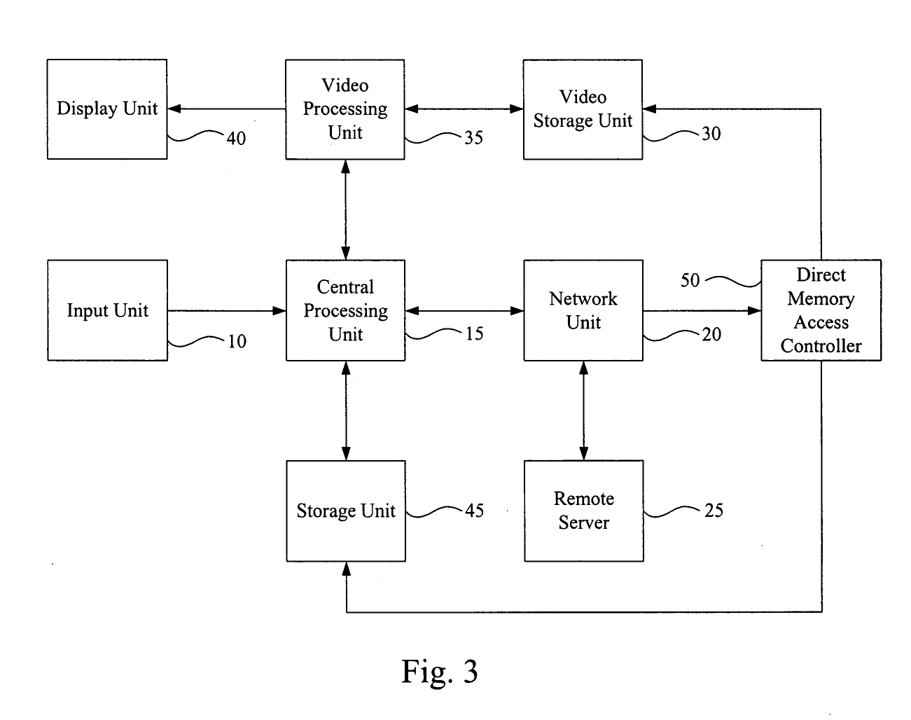

Refer to FIG. 3, the difference between this embodiment and above embodiment is that the video storage unit 30 and the storage unit 45 are coupled with a Direct Memory Access Controller (DMAC) 50 respectively so that the audio/video data downloaded by the network unit 20 is controlled and transmitted to the video storage unit 30 or the storage unit 45 directly by the direct memory access controller 50, without through the processing of the central processing unit 15. When displaying the audio/video data, the decoding of the data is run by the video processing unit 35, without the need of the central processing unit 15. Therefore, when the computer system downloads and displays the audio/video data, the central processing unit 15 only needs to send a connection signal to the network unit 20 for internet connection, later the central processing unit 15 enters the sleep mode for saving electricity.

In summary, a method for computer systems to load audio/video data from remote servers in accordance with the present invention provides users a network unit 20 in a computer system to download audio/video data of programs or movies they want to watch into the computer system for display through internet connection with a remote server 25. Thus users can watch their favorite programs or movies whenever they have time, without the need to go to video stores. It's convenient for users. When watching programs or movies, the display windows and background of the display unit 40 are changed simultaneously according to the topic of the programs or movies being displayed so as to increase the visual effect. Furthermore, when the audio/video data is downloaded, it can be downloaded directly into the storage unit 45 or the video storage unit 30 of the computer system without through the processing of the central processing unit 15. Thus the work loading of the central processing unit 15 is reduced and the electricity is saved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A method for computer systems to load audio/video data from remote servers comprising the steps of:
providing a first operating system and a second operating system installed in a computer system;
receiving an initial signal by a central processing unit of the computer system;
executing the second operating system by the central processing unit;
sending a connection signal to a network unit of the computer system by the central processing unit under the second operating system; connecting to a remote server for downloading at least one piece of audio/video data; and
displaying the data on a display unit of the computer system.

2. The method as claimed in claim 1, wherein the second operating system is an operating system that is executed after the computer system being booted.

3. The method as claimed in claim 1, wherein the initial signal is a remote control signal.

4. The method as claimed in claim 1, wherein when the computer system is under the first operating system after the initial signal being received by the central processing unit, the central processing unit temporarily halts the execution of the first operating system and then executes the second operating system.

5. The method as claimed in claim 1, wherein during the step of connecting to the remote server for downloading the audio/video data, display windows and background information related to the topic of the audio/video data are also downloaded to the computer system and are displayed together with the audio/video data.

6. The method as claimed in claim 1, wherein during the step of connecting to the remote server for downloading the audio/video data, the network unit transmits the audio/video data directly into a video storage unit of the computer system through a direct memory access controller of the computer system.

7. The method as claimed in claim 1, wherein during the step of connecting to the remote server for downloading the audio/video data, the audio/video data is downloaded and stored into a storage unit of the computer system.

8. The method as claimed in claim 7, wherein the network unit transmits the audio/video data directly into the storage unit of the computer system through a direct memory access controller of the computer system.

9. The method as claimed in claim 7, wherein an index stable is established simultaneously when the audio/video data is stored into the storage unit for recording the locations of the audio/video data inside the storage unit.

10. The method as claimed in claim 9, wherein the index table records locations of each I frame of Moving Picture Experts Group (MPEG) data.

11. The method as claimed in claim 7, wherein during the step of storing the audio/video data into the storage unit, a storage file is opened on the storage unit by the computer system for saving the audio/video data; after a period of time, the computer system opens another storage file and keeps saving the audio/video data on the storage file until all the audio/video data has been downloaded.

12. The method as claimed in claim 7, wherein during the step of storing the audio/video data into the storage unit, a storage file is opened on the storage unit by the computer system for saving the audio/video data; after certain amount of audio/video data being downloaded, the computer system opens another storage file and keeps saving the audio/video data on the storage file until all the audio/video data has been downloaded.

13. The method as claimed in claim 1, wherein the first operating system is a Windows operating system.

14. The method as claimed in claim 1, wherein the second operating system is a Linux operating system.

15. The method as claimed in claim 1, wherein the second operating system shares application programs installed in the first operating system with the first operating system.
